(19) United States
(12) Patent Application Publication
(10) Pub. No.: US 2007/0220597 A1
(43) Pub. Date: Sep. 20, 2007

(54) VERIFICATION SYSTEM

(76) Inventor: Natsuki ISHIDA, Tokyo (JP)

Correspondence Address: MATTINGLY, STANGER,;MALUR & BRUNDIDGE, P.C., Suite 370, 1800 Diagonal Road, Alexandria, VA, 22314, US

(21) Appl. No.: 11/685,818

(22) Filed: Mar. 14, 2007

(30) Foreign Application Priority Data
Mar. 17, 2006 (JP) 2006-73761

(51) Int. Cl. G06F 17/30

(52) U.S. Cl. 726/8

(57) ABSTRACT

A verification system in which a client terminal can safely receive online service from an online service server. The verification system includes an online service server, an information terminal device for receiving online service, an OTP server for performing a process involving login verification of the information terminal device and verification of online service transaction contents, and a portable terminal device that displays an OTP used for login verification and transaction contents verification. The portable terminal device includes means for transmitting, to the OTP server, separate acquisition requests for a login-verifying OTP and a transaction-contents-verifying OTP that the information terminal device requires when receiving online service from the online service server, receiving a login verifying OTP and a transaction contents verifying OTP from the OTP server, and displaying them.

### BACKGROUND OF THE INVENTION

1. Field of the Invention

The present invention relates to a verification system and more particularly to a verification system suitable for the verification of clients (users) and contents (e.g., transaction contents) of online service, such as Web shopping, provided by an online service server to a client terminal via a network such as the Internet.

2. Background Art

When an online service server provides online services such as Web shopping to client terminals via a network such as the Internet, it is necessary to verify that the client who requested such service is an authorized client registered in the online service server in advance, in order to prevent unlawful transaction.

As a relevant technology to verify the client, a verification system is known in which the client is verified using a fixed password that is set for the client in advance.

In such verification system based on the fixed password, there is the problem that the fixed password, which is not frequently changed, could be unlawfully reused once leaked through a key logger or the like.

As a technology to address such potential danger in verifying the client in a client/server system, a verification system is known in which a onetime password is utilized.

One type of verification system utilizing the onetime password is disclosed in JP Patent Publication (Kokai) No. 2002-259344 A, in which the onetime password is synchronized with the current time. In this system, the client terminal and the online service server independently compute onetime passwords based on client ID (online service user ID), a fixed password, and the current time, using a secure hash function. The client is verified using the thus computed onetime passwords.

In such verification system, since the onetime password is frequently changed depending on time, the chances of the onetime password being reused once leaked through a key logger or the like can be reused.

### SUMMARY OF THE INVENTION

The above conventional verification system utilizing onetime password as described above has the following problems.

In a first problem, the system does not distinguish between the onetime password for client verification upon login to the online service server and the onetime password for transaction contents verification for verifying the provided online service contents (transaction contents). Therefore, if the onetime password for client verification should be leaked by spyware or the like on a real-time basis, the leaked client-verifying onetime password could be unlawfully used by a third party with malicious intent for unlawfull acts, such as tampering with transaction contents.

In a second problem, because the onetime password that is entered in the online service client consists of not more than several digits of characters for the sake of user convenience, the onetime password is weak, and a stronger onetime password having greater number of characters cannot be easily entered.

It is therefore a first object of the invention to provide a verification system in which the client terminal can safely receive online service from an online service server.

It is a second object of the invention to provide a verification system in which a onetime password having a large number of characters and therefore greater strength can be easily entered.

In order to achieve the aforementioned objects, in one aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and a portable terminal device owned by the user of the information terminal device who receives online service, the portable terminal device being used for displaying onetime passwords used for login verification and transaction contents verification.

The onetime password server carries out login verification for online service and verification of transaction contents concerning online service using onetime passwords received from the information terminal device.

The portable terminal device comprises: means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords.

In another aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and a portable terminal device owned by the user of the information terminal device who receives online service, the portable terminal device being used for displaying an onetime password used for login verification and transaction contents verification.

The onetime password server carries out login verification for online service and verification of transaction contents concerning online service using onetime passwords received from the information terminal device.

The information terminal device comprises: means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor; means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and means for transmitting the transaction preparation information to the portable terminal device, and receiving the transaction-contents-verifying onetime password that is extracted by decoding the transaction preparation information in the portable terminal device using the common key shared with the onetime password server.

In another aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and a portable terminal device owned by the user of the information terminal device who receives online service, the portable terminal device being used for displaying onetime passwords used for login verification and transaction contents verification.

The onetime password server carries out login verification for online service and verification of transaction contents concerning online service using onetime passwords received from the information terminal device.

The information terminal device comprises: means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen.

The portable terminal device comprises: means for restoring the challenge by decoding the two-dimensional code of the challenge displayed on a display screen of the information terminal device, and displaying a login-verifying onetime password generated using the challenge as a factor; and means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

In yet another aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and a portable terminal device owned by the user of the information terminal device who receives online service, the portable terminal device being used for displaying onetime passwords used for login verification and transaction contents verification.

The onetime password server carries out login verification for online service and verification of transaction contents concerning online service using onetime passwords received from the information terminal device.

The portable terminal device comprises: means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords.

The information terminal device comprises: means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor; means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and means for transmitting the transaction preparation information to the portable terminal device, and receiving the transaction-contents-verifying onetime password that is extracted by decoding the transaction preparation information in the portable terminal device using the common key shared with the onetime password server.

In yet another aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and a portable terminal device owned by the user of the information terminal device who receives online service, the portable terminal device being used for displaying onetime passwords used for login verification and transaction contents verification.

The onetime password server carries out login verification for online service and verification of transaction contents concerning online service using onetime passwords received from the information terminal device.

The portable terminal device comprises: means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords.

The information terminal device comprises: means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen.

The portable terminal device comprises: means for restoring the challenge by decoding the two-dimensional code of the challenge displayed on a display screen of the information terminal device, and displaying a login-verifying onetime password generated using the challenge as a factor; and means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

In still another aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and a portable terminal device owned by the user of the information terminal device who receives online service, the portable terminal device being used for displaying onetime passwords used for login verification and transaction contents verification.

The onetime password server carries out login verification for online service and verification of transaction contents concerning online service using onetime passwords received from the information terminal device.

The information terminal device comprises: means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor; means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and means for transmitting the transaction preparation information to the portable terminal device, and receiving the transaction-contents-verifying onetime password that is extracted by decoding the transaction preparation information in the portable terminal device using the common key shared with the onetime password server.

The information terminal device comprises: means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen.

The portable terminal device comprises: means for restoring the challenge by decoding the two-dimensional code of the challenge displayed on a display screen of the information terminal device, and displaying a login-verifying onetime password generated using the challenge as a factor; and means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

In another aspect, the invention provides a verification system which comprises: an online service server for providing online service; an information terminal device for receiving online service; a onetime password server for carrying out a process relating to the verification of login of the information terminal device onto the online service server and the verification of transaction contents of online service; and portable terminal device owned by the user of the information terminal device who receives online service, the portable terminal device being used for displaying onetime passwords used for login verification and transaction contents verification.

The onetime password server carries out login verification for online service and verification of transaction contents concerning online service using onetime passwords received from the information terminal device.

The portable terminal device comprises: means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords.

The information terminal device comprises: means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor; means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and means for transmitting the transaction preparation information to the portable terminal device, and receiving the transaction-contents-verifying onetime password that is extracted by decoding the transaction preparation information in the portable terminal device using the common key shared with the onetime password server.

The information terminal device comprises: means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen.

The portable terminal device comprises: means for restoring the challenge by decoding the two-dimensional code of the challenge displayed on a display screen of the information terminal device, and displaying a login-verifying onetime password generated using the challenge as a factor; and means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

Preferably, the onetime password server comprises: means for receiving, from the information terminal device via the online service server, a login verification request including a login-verifying onetime password and a transaction verification request including a transaction-contents-verifying onetime password, and identifying the type of the received login-verifying onetime password and the transaction-contents-verifying onetime password based on the strength of the login-verifying onetime password and that of the transaction-contents-verifying onetime password.

Preferably, the information terminal device and the portable terminal device each comprise a wireless interface or an IC card interface for the transmission and reception of the challenge, login-verifying onetime password, transaction preparation information, and transaction-contents-verifying onetime password, using a wireless signal.

### EFFECTS OF THE INVENTION

In accordance with the invention, the onetime password server transmits a login-verifying onetime password in response to the reception of a request therefor, while it transmits a onetime password for transaction contents verification in response to the reception of a request therefor. Alternatively, the information terminal device reads and decodes a two-dimensional code displayed on the portable terminal device, and then generates a login-verifying onetime password or a onetime password for transaction contents verification depending on the identifying bit sequence contained in the decoded information. Thus, the login-verifying onetime password and the onetime password for transaction contents verification are generated separately. As a result, it becomes possible to solve the first problem of the conventional verification system using onetime passwords, namely, the possibility of such onetime passwords being leaked in real-time through the use of spyware or the like and used for unlawful transaction verification purposes. Thus, the invention makes it possible to provide online service safely.

Furthermore, the onetime passwords required by the information terminal device for login verification and transaction contents verification are transmitted from the portable terminal device. In this way, it becomes possible to employ onetime passwords consisting of a large number of characters and thus having greater strength. Thus, the second problem of the conventional verification system using onetime passwords can be solved, and a highly safe online service can be provided.

By identifying the type of the onetime password contained in the verification request received by the onetime password server based on its strength, it becomes possible for the onetime password server to carry out the verification process depending on the type of the onetime password. For example, a type of onetime password to be acquired by the online service user can be selected depending on the radio condition of the portable terminal device, whether or not the portable terminal device includes an IC card or a wireless communication port, or whether or not the portable terminal device has a camera function, for example, and then the verification process can be carried out in accordance with the type.

### BRIEF DESCRIPTION OF THE DRAWINGS

FIG. 1 shows a configuration of the verification system of the invention.

FIG. 2 shows an example of the detailed configuration of an online service server and a onetime password server in the verification system of the invention.

FIG. 3 shows an example of the detailed configuration of an information terminal device and a portable terminal device in the verification system of the invention.

FIG. 4 shows an example of information stored in a database in the verification system of the invention.

FIG. 5 shows an example of a login verification screen display process in the verification system of the invention.

FIG. 6 shows an example of a login verification screen in the verification system of the invention.

FIG. 7 shows an example of a login OTP (download method) acquisition process in the verification system of the invention.

FIG. 8 shows an example of a login OTP (two-way communication method) acquisition process in the verification system of the invention.

FIG. 9 shows an example of a login OTP (one-way communication method) acquisition process in the verification system of the invention.

FIG. 10 shows an example of a login verification process in the verification system of the invention.

FIG. 11 shows an example of a transaction verification screen display process in the verification system of the invention.

FIG. 12 shows an example of a transaction verification screen in the verification system of the invention.

FIG. 13 shows an example of a transaction OTP (download method) acquisition process in the verification system of the invention.

FIG. 14 shows an example of a transaction OTP (two-way communication method) acquisition process in the verification system of the invention.

FIG. 15 shows an example of a transaction OTP (one-way communication method) acquisition process in the verification system of the invention.

FIG. 16 shows an example of a transaction verification process in the verification system of the invention.

FIG. 17 shows an outline of processes relating to transaction in the verification system of the invention.

### DESCRIPTION OF THE PREFERRED EMBODIMENTS

In the following, an embodiment of the verification system of the invention will be described with reference to the drawings.

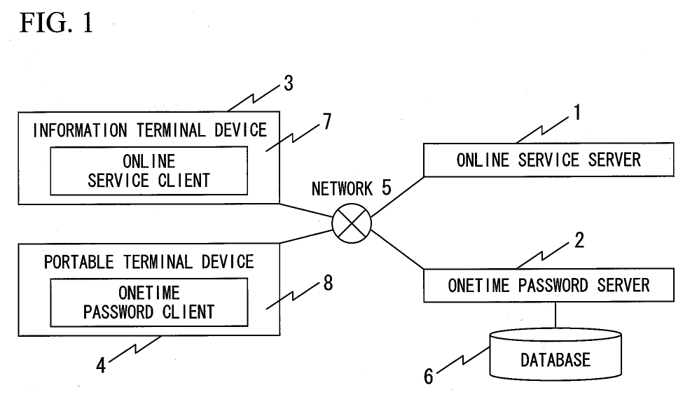

FIG. 1 shows an overall block diagram of a verification system according to an embodiment of the invention. The verification system includes: an online service server 1 for providing online service such as Web shopping; a onetime password server 2 for generating a onetime password for online service; an information terminal device 3 for receiving online service; and a portable terminal device 4 owned by the user of the information terminal device 3. These components of the system are connected via a network 5 such as the Internet.

To the onetime password server 2, a database 6 is connected in which information about the user who receives online service is stored, for example.

The online service server 1 corresponds to a Web server that provides online service such as Web shopping. The onetime password server 2 corresponds to a Web service server that generates a onetime password.

The information terminal device 3 consists of a personal computer or the like used by the user who receives online service. It implements an online service client 7.

The portable terminal device 4 consists of a cellular phone or the like owned by the user who receives online service. It implements a onetime password client 8.

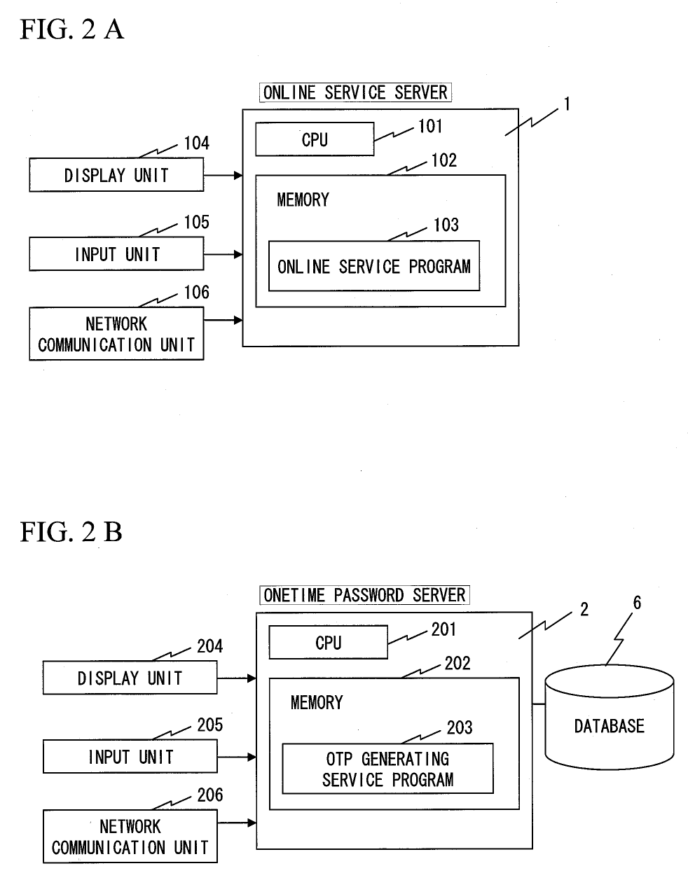

FIG. 2 shows a block diagram of the details of the online service server 1 and the onetime password server 2.

The online service server 1 includes a CPU 101 and a memory 102 in which an online service program 103 is stored. The online service server 1 also includes a display unit 104, an input unit 105, and a network communication unit 106.

The onetime password server 2 includes a CPU 201 and a memory 202 in which a onetime password generating service program 203 is stored.

The onetime password server 2 further includes a display unit 204, an input unit 205, and a network communication unit 206, and it can access a database 6.

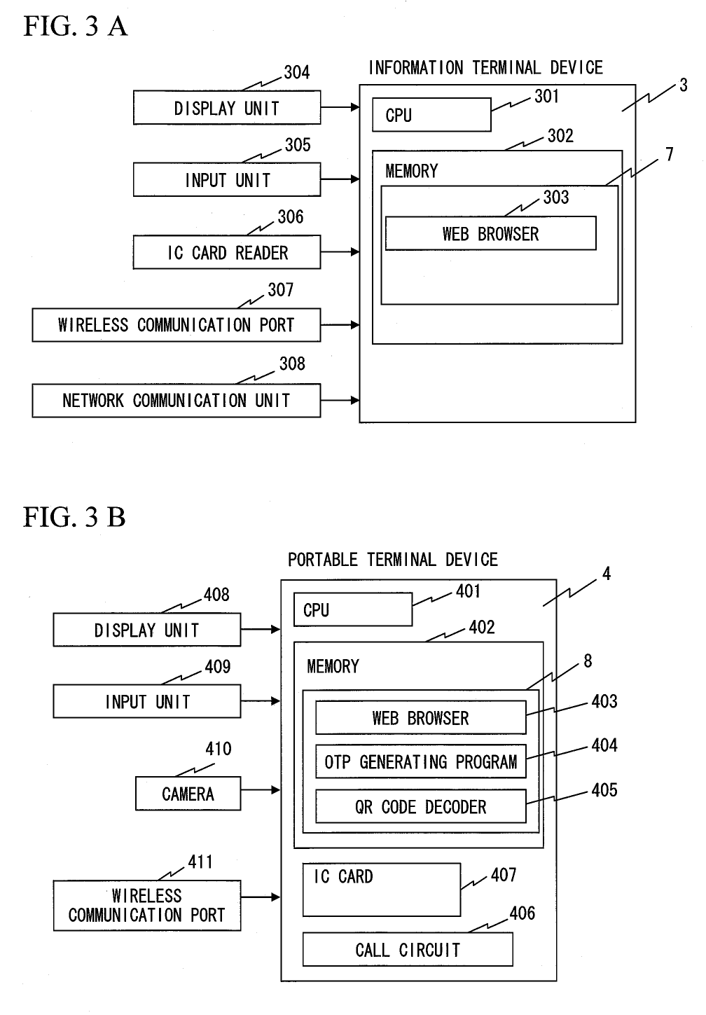

FIG. 3 shows a block diagram of the details of the information terminal device 3 and the portable terminal device 4.

The information terminal device 3 includes a CPU 301 and a memory 302 in which an online service client 7 that can receive online service is stored. The online service client 7 consists of a Web browser 303, for example. The information terminal device 3 also includes a display unit 304, an input unit 305, an IC card reader 306, a wireless communication port 307, and a network communication unit 308.

The portable terminal device 4 includes a CPU 401 and a memory 402 in which a onetime password client 8 is stored. The onetime password client 8 is composed of, e.g., a Web browser 403, a onetime password generating program 404, and a QR code decoder 405. The portable terminal device 4 further includes a call function unit such as a call circuit 406 necessary for a call, and an IC card 407 enabling transmission and reception of stored information to and from an external IC card reader using weak radio wave. The portable terminal device further includes a display unit 408, an input unit 409 such as a keypad, a camera 410, and a wireless communication port 411.

The IC card 407 stores a onetime password (to be hereinafter referred to as “OTP”) generated by the onetime password generating program 404. The stored OTP is transferred to the information terminal device 3 by weak radio wave as the portable terminal device 4 is placed above a reading position of the IC card reader 306 of the information terminal device 3.

The camera 410 is used when reading a QR code (two-dimensional bar code) displayed on the display unit 304 of the information terminal device 3.

The wireless communication port 411 is used when transmitting the OTP generated by the OTP generating program 404 to the information terminal device 3 via the wireless communication port 307 of the information terminal device 3.

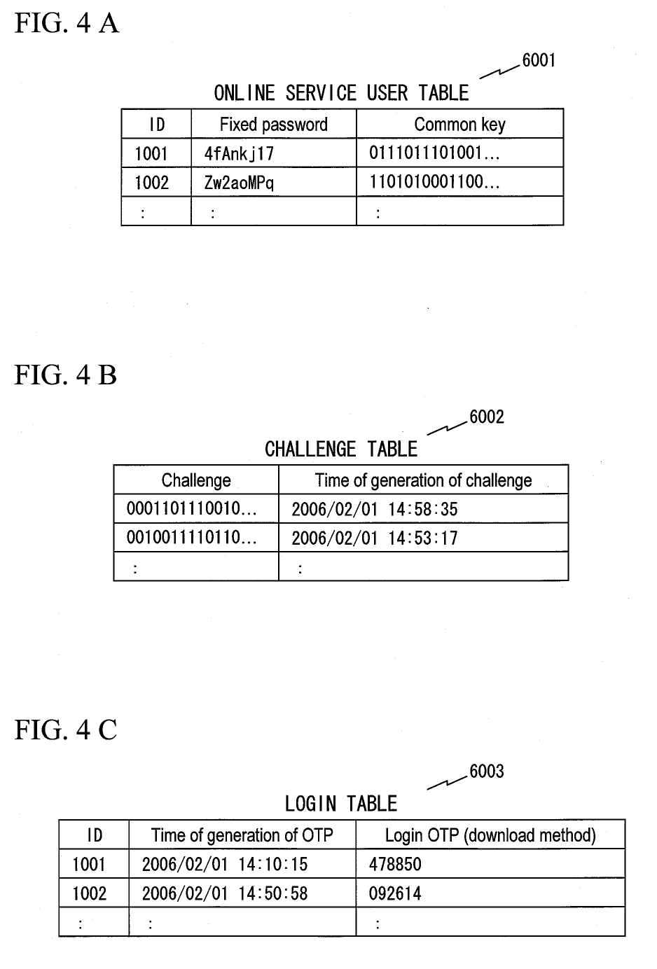

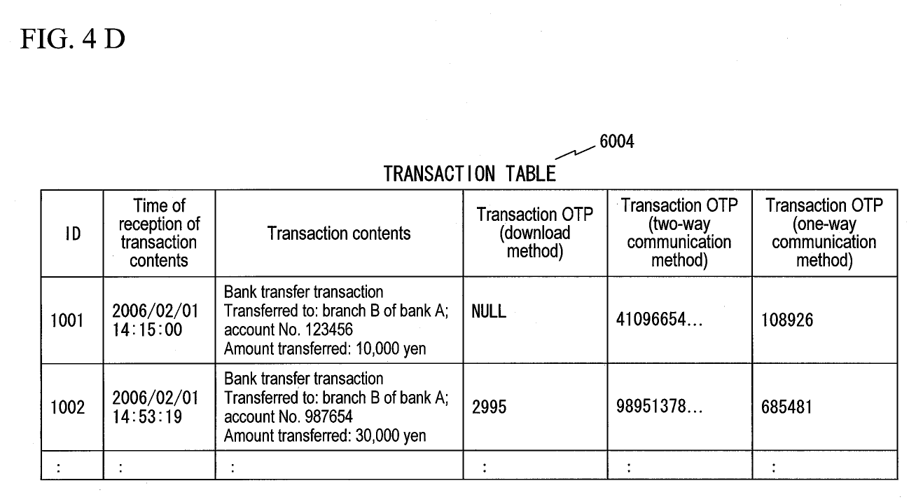

FIG. 4 shows examples of the information stored in the database 6, such as an online service user table 6001, a challenge table 6002, a login table 6003, and a transaction table 6004.

The online service user table 6001 stores user ID's, fixed passwords, and common keys.

The challenge table 6002 stores challenges generated by the onetime password server 2 and the time of generation.

The login table 6003 stores the time of generation of OTP's for login and the OTP's for login by user ID.

The OTP's for login refer to those OTP's for verification of the user who receives online service; they are OTP's for client verification. In the following, they are referred to as login OTP's

The transaction table 6004 stores the time of reception of transaction contents, transaction contents, and OTP's for transaction contents verification, by user ID.

The “OTP's for transaction contents verification” herein refer to those OTP's that vary depending on the provided online service contents (transaction contents). In the following, they are referred to as transaction OTP's.

In accordance with the invention, there are three methods regarding the login OTP and transaction OTP. In a download method, the OTP's are generated by the onetime password server 2 and the generated OTP's are downloaded to the portable terminal device 4. In a two-way communication method, the OTP's are generated in the portable terminal device 4 in accordance with an instruction from the information terminal device 3, and they are returned to the information terminal device 3 where they are used. In a one-way communication method, a QR code displayed on the information terminal device 3 is photographed with the camera in the portable terminal device 4 and decoded, and OTP's generated on the basis of the decoding result are displayed.

The download method is utilizable in an environment such that the portable terminal device 3 has good radio condition and can communicate with the onetime password server 2.

The two-way communication method is utilizable in an environment that permits the combination of the IC card 407 and the IC card reader 306 of the information terminal device 3, or the combination of the wireless communication port 411 of the portable terminal device 4 and the wireless communication port 307 of the information terminal device 3.

The two-way communication method allows the automatic entry of an OTP consisting of a large number of characters on the OTP input screen on the online service client's end. As a result, it becomes possible to enter an OTP with a high strength and carry out a safe and robust verification process.

The one-way communication method is utilizable in an environment where the portable terminal device 4 has a built-in camera available.

In the following, the types and features of OTP's used in the verification system of the invention will be described.

The strengths are different among the login OTP (download method), the login OTP (two-way communication method), and the login OTP (one-way communication method).

The strengths are different among the transaction OTP (download method), the transaction OTP (two-way communication method), and the transaction OTP (one-way communication method).

That the strengths of OTP's are different means that the OTP's have different numbers of characters, for example.

Namely, when a login OTP (download method) consists of a number a of characters (such as six numerical characters), a login OTP (two-way communication method) consists of a number b of characters (such as 32 numerical characters), and a login OTP (one-way communication method) consists of a number c of characters (such as eight numerical characters), the values of a, b, and c are different.

Further, when a transaction OTP (download method) consists of a number x of characters (such as four numerical characters), a transaction OTP (two-way communication method) consists of a number y of characters (such as 32 numerical characters), and a transaction OTP (one-way communication method) consists of a number z of characters (such as six numerical characters), the values of x, y, and z are different.

It is noted that the passwords are not limited to sequences of numerical characters alone.

The initial status of the verification system of the invention will be described.

In the initial status, the database 6 has user ID's, fixed passwords, and common keys stored in the online service user table 6001, as shown in FIG. 4.

The portable terminal device 4 has stored the ID of the owner of the device corresponding to the online service user, and shared secret information. In the following, the shared secret information is described as consisting of a common key K that forms a pair with a fixed password.

Alternatively, the verification process and the OTP computing process using a fixed password and the encoding/decoding process and the MAC (Message Authentication Code) adding/verifying process using the common key cryptosystem can be performed using a public key encryption system.

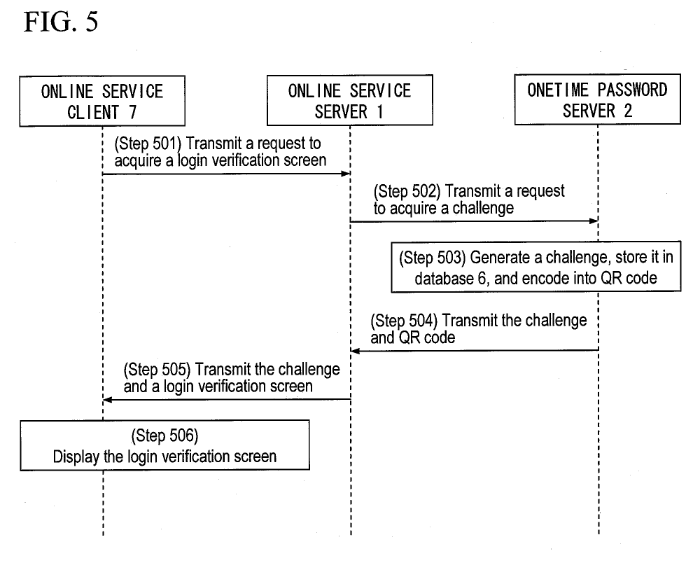

Of the processes performed by the verification system of the invention, an example of a login verification screen display process is described with reference to FIG. 5.

In step 501, the online service client 7 transmits a login verification screen acquisition request to the online service server 1.

In step 502, the online service server 1 transmits a challenge acquisition request to the onetime password server 2.

In step 503, the onetime password server 2 generates a challenge according to a challenge response system randomly, stores the challenge and the time of its generation in the challenge table 6002 in the database 6, and then encodes a combined bit sequence of a challenge identifying bit sequence and the challenge into a QR code.

In step 504, the onetime password server 2 transmits the challenge and the QR code to the online service server 1.

In step 505, the online service server 1 transmits the challenge and a login verification screen to the online service client 7.

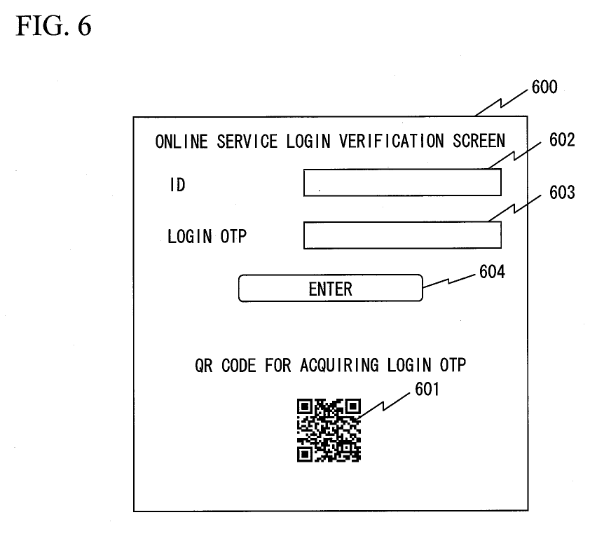

In step 506, the online service client 7 causes a login verification screen 600 to be displayed on the display unit 304 of the information terminal device 3, the screen consisting of a QR code 601 for the acquisition of a login OTP, an ID input field 602, a login OTP input field 603, and a login verification process enter button 604, as shown in FIG. 6.

The QR code 601 is read by the camera 410 in the portable terminal device 4 so as to generate a login OTP using a challenge contained in the QR code 601.

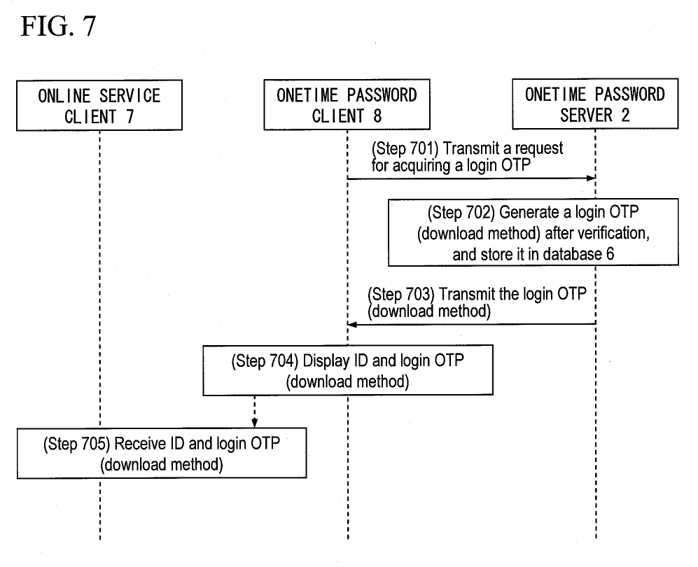

In the following, of the processes performed by the verification system of the invention, an example of a login OTP (download method) acquisition process is described with reference to FIG. 7.

In step 701, the onetime password client 8 transmits a login OTP acquisition request including a set of ID and a fixed password to the onetime password server 2.

In step 702, if the received set of ID and a fixed password is stored in the online service user table 6001 of the database 6, the onetime password server 2 generates a login OTP (download method) randomly and stores the ID, the time of generation of the OTP, and the login OTP (download method) in the login table 6003 of the database 6.

In step 703, the onetime password server 2 transmits the login OTP (download method) to the onetime password client 8.

In step 704, the onetime password client 8 causes the ID and login OTP (download method) to be displayed on the display unit 408 of the portable terminal device 4.

In step 705, the online service client 7 accepts the ID and the login OTP (download method) manually entered by the online service user on the login verification screen 600 shown in FIG. 6.

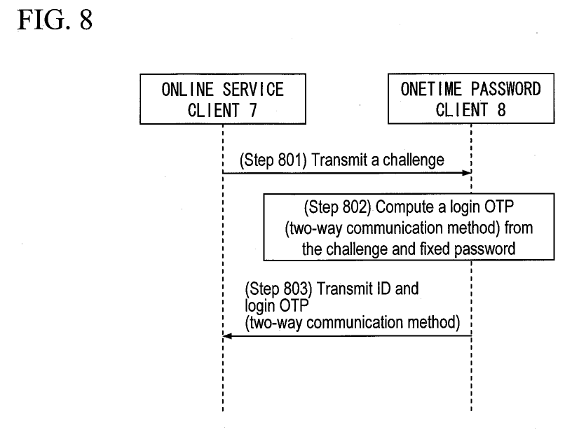

In the following, of the processes performed by the verification system of the invention, an example of a login OTP (two-way communication method) acquisition process is described with reference to FIG. 8.

The login OTP acquisition process in the present two-way communication method is carried out on the basis of the combination of the IC card 407 contained in the portable terminal device 4 and the IC card reader 306 of the information terminal device 3, or the combination of the wireless communication port 411 of the portable terminal device 4 and the wireless communication port 307 of the information terminal device 3.

In step 801, the online service client 7 transmits a challenge to the onetime password client 8. The challenge is the one that has been received from the onetime password server 2 in step 505 of FIG. 5 and then stored in the online service client 7.

In step 802, the onetime password client 8 computes a login OTP (two-way communication method) from the challenge and the fixed password.

For example, a secure hash value is calculated from the challenge and the fixed password using a secure hash function. Then, a character string consisting of a number b of numerical characters is calculated from the secure hash value using a hash function, and then used as a login OTP (two-way communication method).

In step 803, the onetime password client 8 transmits the ID and the login OTP (two-way communication method) to the online service client 7 using either the combination of the IC card 407 contained in the portable terminal device 4 and the IC card reader 306 of the information terminal device 3, or the combination of the wireless communication port 411 of the portable terminal device 4 and the wireless communication port 307 of the information terminal device 3.

The online service client 7 then causes the received ID and login OTP (two-way communication method) to be displayed on the login verification screen 600. In this case, the online service user does not need to manually enter the ID and login OTP (two-way communication method).

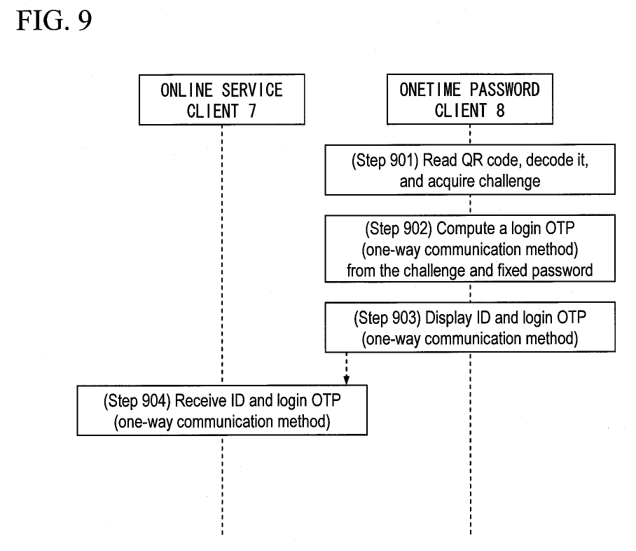

In the following, of the processes performed by the verification system of the invention, an example of a login OTP (one-way communication method) acquisition process is described with reference to FIG. 9.

In this login OTP acquisition process in the one-way communication method, the QR code displayed on the display unit 304 of the information terminal device 3 is photographed with the camera 410 built inside the portable terminal device 4, and then a login OTP is generated by decoding the QR code and displayed.

In step 901, the onetime password client 8 reads, using the camera 410, the QR code (601 of FIG. 6) displayed by the online service client 7. The client then decodes the QR code with the QR code decoder 405. If the initial bit sequence of the decoded information is identical to the challenge identifying bit sequence, the bit sequence of the decoded information subsequent to the challenge identifying bit sequence is considered to be a challenge and used in step 902 and the subsequent steps.

In step 902, the onetime password client 8 computes a login OTP (one-way communication method) from the challenge and the fixed password.

For example, a secure hash value is calculated from the challenge and the fixed password using a hash function, and then a character string consisting of a number c of numerical characters is calculated from the secure hash value using a hush function and used as a login OTP (one-way communication method).

In step 903, the onetime password client 8 displays the ID and the login OTP (one-way communication method).

In step 904, the online service client 7 accepts the ID and login OTP (one-way communication method) manually entered on the login verification screen 600 of FIG. 6 by the online service user.

Alternatively, it is also possible to have the ID and login OTP (one-way communication method) automatically entered on the login verification screen 600 using the combination of the IC card 407 contained in the portable terminal device 4 and the IC card reader 306 of the information terminal device 3, or the combination of the wireless communication port 411 of the portable terminal device 4 and the wireless communication port 307 of the information terminal device 3.

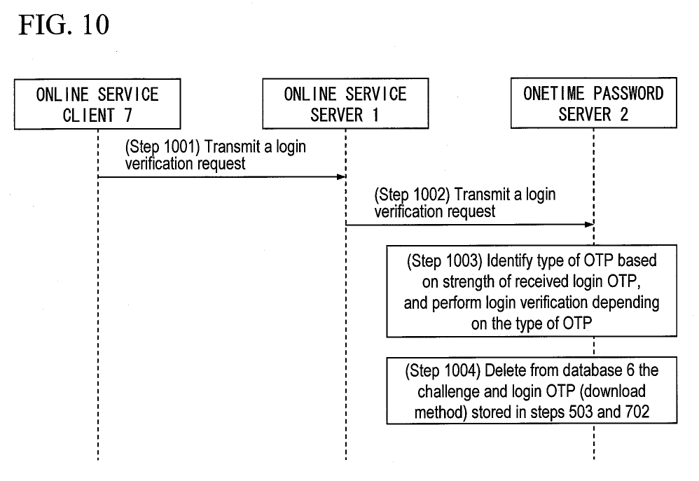

In the following, of the processes performed by the verification system of the invention, an example of a login verification process will be described with reference to FIG. 10.

In step 1001, the online service client 7 transmits a login verification request to the online service server 1, the request including a set of the ID and login OTP entered via the login verification screen 600 and the challenge received from the online service server 1.

Step 1001 is carried out upon pressing of the login verification process enter button 604 by the online service user.

In step 1002, the online service server 1 transmits a login verification request to the onetime password server 2, the request including the set of ID, login OTP, and challenge.

In step 1003, the type of OTP is identified from the strength of the received login OTP, and then a login verification process is carried out depending on the type of the login OTP.

The “login verification process depending on the type of login OTP” means the following:

(a) Login verification is considered a success if the strength of the login OTP received by the onetime password server 2 is equal to the strength of the login OTP (download method), the set of the received ID and the login OTP is stored in the login table 6003 of the database 6, and the current time is within a certain duration of time from the time of generation of the OTP.
(b) Login verification is considered a success if the strength of the login OTP received by the onetime password server 2 is equal to the strength of the login OTP (two-way communication method), the received challenge is stored in the challenge table 6002 of the database 6, the current time is within a certain duration of time from the time of generation of the challenge, and the received login OTP is equal to a login OTP (two-way communication method) calculated from the challenge and a fixed password corresponding to the received ID, the fixed password being acquired from the online service user table 6001 of the database 6.

For example, a secure hash value is calculated from the challenge and the fixed password using a secure hash function, and then a character string consisting of a number b of numerical characters is calculated from the secure hash value using a hash function and used as a login OTP (two-way communication method).

(c) Login verification is considered a success if the strength of the login OTP received by the onetime password server 2 is equal to the strength of the login OTP (one-way communication method), the received challenge is stored in the challenge table 6002 of the database 6, the current time is within a certain duration of time from the time of generation of the challenge, and the received login OTP is equal to a login OTP (one-way communication method) calculated from the challenge and a fixed password corresponding to the received ID, the fixed password being acquired from the online service user table 6001 of the database 6.

For example, a secure hash value is calculated from the challenge and the fixed password using a secure hash function, and then a character string consisting of a number c of numerical characters is calculated from the secure hash value using a hash function and is used as a login OTP (one-way communication method).

In step 1004, the onetime password server 2 deletes records containing the received challenge from the challenge table 6002 of the database 6, and further deletes records containing the received ID from the login table 6003 of the database 6.

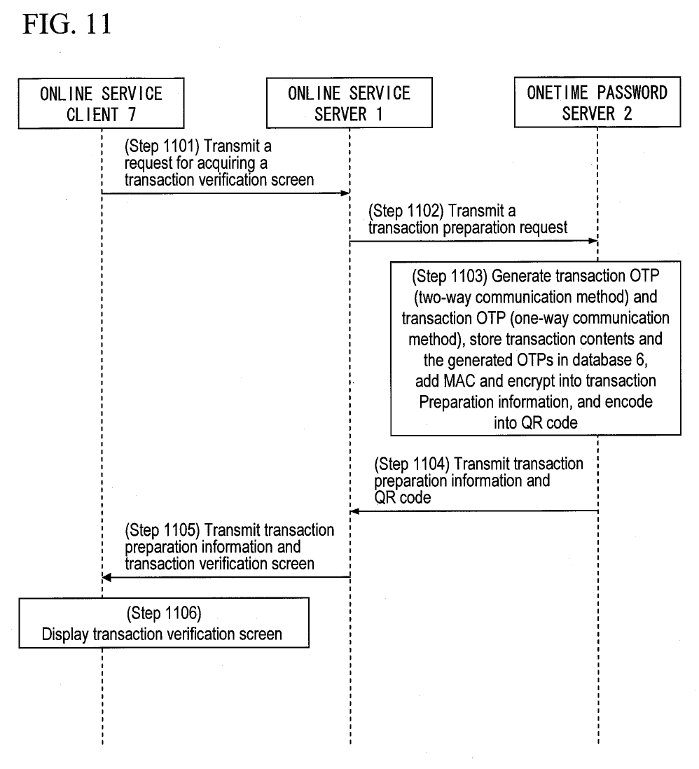

In the following, of the processes performed by the verification system of the invention, an example of a transaction verification screen display process is described with reference to FIG. 11.

In step 1101, the online service client 7 transmits a transaction verification screen acquisition request to the online service server 1, the request including a set of ID and transaction contents.

The transaction contents refer to information about the buying/selling of a product, bank transfer, and so on.

In step 1102, the online service server 1 transmits a transaction preparation request to the onetime password server 2, the request including the set of ID and transaction contents.

In step 1103, the onetime password server 2 sets the transaction OTP (download method) to a NULL value, randomly generates a transaction OTP (two-way communication method) and a transaction OTP (one-way communication method), and have the ID, transaction contents reception time, transaction contents, transaction OTP (download method), transaction OTP (two-way communication method), and transaction OTP (one-way communication method) stored in the transaction table 6004 of the database 6. The onetime password server 2 further acquires a common key K corresponding to the received ID from the online service user table 6001 of the database 6, adds a MAC, using the common key K, to the plain text consisting of the combined bit sequence of the transaction contents, the transaction OTP (two-way communication method), and the transaction OTP (one-way communication method). The MAC is generated by a MAC generating algorithm. The onetime password server 2 then encrypts the plain text with a common key cryptosystem and using the common key K. The onetime password server 2 then encodes the combined bit sequence of the transaction preparation information identifying bit sequence and the transaction preparation information into a QR code for the acquisition of a transaction OTP.

It is noted that the transaction preparation information identifying bit sequence is a bit sequence different from the challenge identifying bit sequence.

In step 1104, the onetime password server 2 transmits the transaction preparation information and the QR code to the online service server 1.

In step 1105, the online service server 1 transmits the transaction preparation information and a transaction verification screen to the online service client 7.

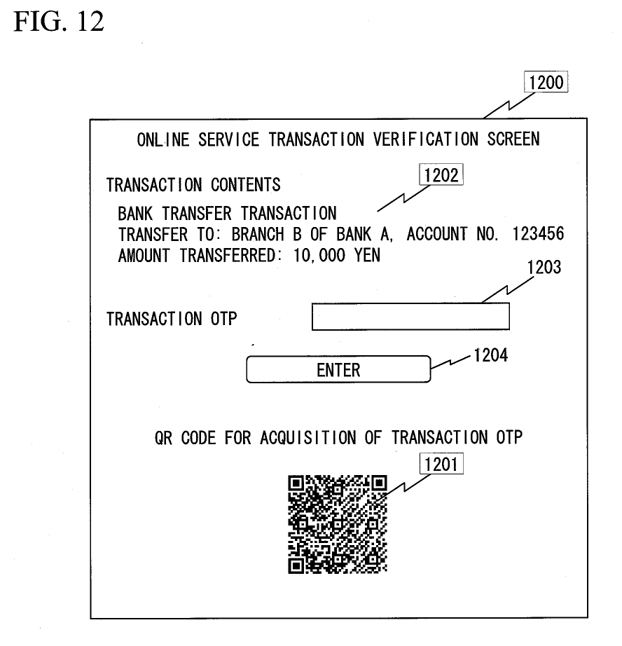

The transaction verification screen 1200 includes a QR code 1201, transaction contents 1202, a transaction OTP input field 1203, and a transaction verification process enter button 1204, as shown in FIG. 12.

In step 1106, the online service client 7 displays the transaction verification screen 1200.

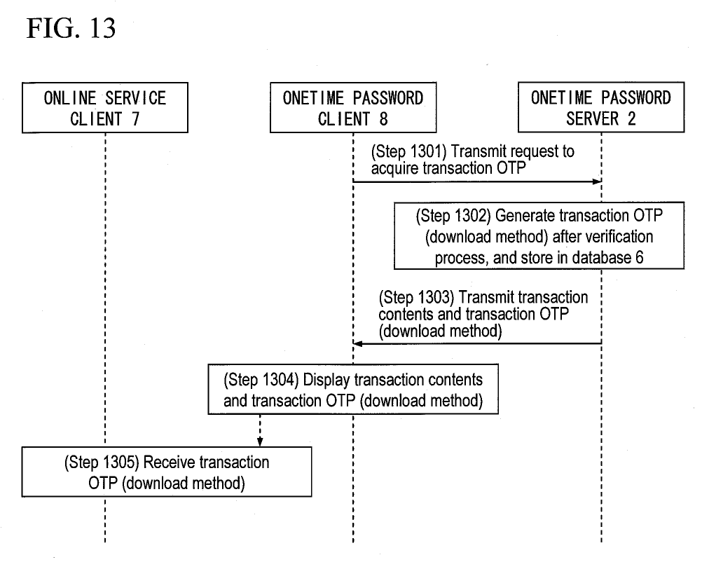

In the following, of the processes performed by the verification system of the invention, an example of a transaction OTP (download method) acquisition process is described with reference to FIG. 13.

In step 1301, the onetime password client 8 transmits a transaction OTP acquisition request to the onetime password server 2, the request including a set of ID and a fixed password.

In step 1302, if the received set of ID and the fixed password is stored in the online service user table 6001 of the database 6, the onetime password server 2 randomly generates a transaction OTP (download method), acquires transaction contents from a record stored in the transaction table 6004 of the database 6 having the received ID, and then stores the transaction OTP (download method).

In step 1303, the onetime password server 2 transmits the transaction contents and the transaction OTP (download method) to the onetime password client 8.

In step 1304, the onetime password client 8 causes the transaction contents and the transaction OTP (download method) to be displayed on the display unit 408.

In step 1305, the online service client 7 accepts the transaction OTP (download method) entered by the online service user on the transaction verification screen 1200.

It is noted that step 1305 is carried out upon confirmation by the online service user of the transaction contents displayed on the onetime password client 8.

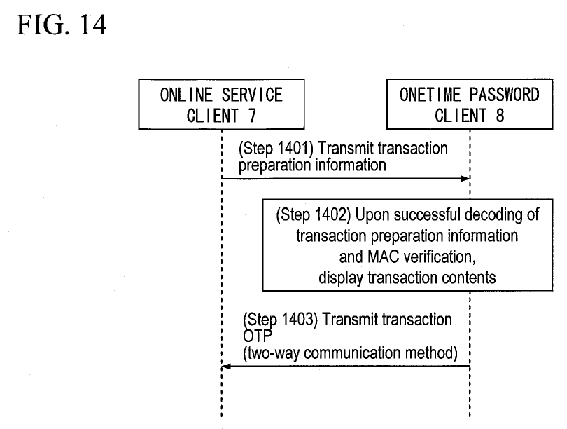

In the following, of the processes performed by the verification system of the invention, an example of a transaction OTP (two-way communication method) acquisition process will be described with reference to FIG. 14.

This transaction OTP acquisition process in the two-way communication method is carried out using the combination of the IC card 407 contained in the portable terminal device 4 and the IC card reader 306 of the information terminal device 3, or the combination of the wireless communication port 411 of the portable terminal device 4 and the wireless communication port 307 of the information terminal device 3.

In step 1401, the online service client 7 transmits transaction preparation information to the onetime password client 8.

In step 1402, the onetime password client 8 displays the transaction contents if it succeeds in decoding the transaction preparation information with the common key K and using a common key cryptosystem and in MAC verification.

In step 1403, the onetime password client 8 transmits a transaction OTP (two-way communication method) to the online service client 7.

It is noted that step 1403 is initiated by bringing the IC card 407 contained in the portable terminal device 4 close to the IC card reader 306 of the information terminal device 3, or by bringing the wireless communication port 411 of the portable terminal device 4 close to the wireless communication port 307 of the information terminal device 3, following the confirmation by the online service user of the transaction contents displayed on the onetime password client 8.

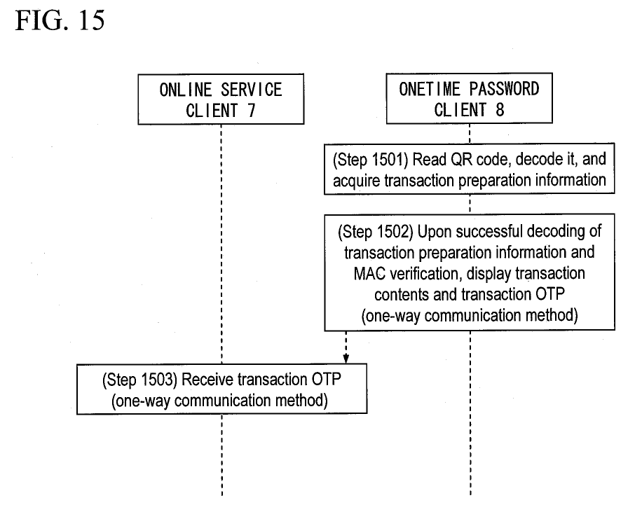

In the following, of the processes performed by the verification system of the invention, an example of a transaction OTP (one-way communication method) acquisition process will be described with reference to FIG. 15.

In this transaction OTP acquisition process in the one-way communication method, the QR code displayed on the display unit 304 of the information terminal device 3 is photographed by the camera 410 contained in the portable terminal device 4, and the QR code is decoded to generate an OTP, which is displayed.

In step 1501, the onetime password client 8 has the QR code 1201 displayed on the display unit 304 of the online service client 7 read by the camera 410 and decoded. If the initial bit sequence of the decoded information is identical to the transaction preparation information identifying bit sequence, the bit sequence of the decoded information subsequent to the transaction preparation information identifying bit sequence is used as transaction preparation information in step 1502 and the subsequent steps.

Alternatively, if the challenge and the transaction preparation information have different bit lengths, it is also possible to determine whether the information decoded in step 901 and step 1501 corresponds to a challenge or transaction preparation information based on the bit length.

In step 1502, if the onetime password client 8 succeeds in decoding the transaction preparation information and verifying the MAC, it causes the transaction contents and the transaction OTP (one-way communication method) to be displayed on the display unit 408.

In step 1503, the online service client 7 accepts the transaction OTP (one-way communication method) entered by the online service user on the transaction verification screen 1200.

It is noted that step 1503 is carried out upon confirmation by the online service user of the transaction contents displayed on the onetime password client 8.

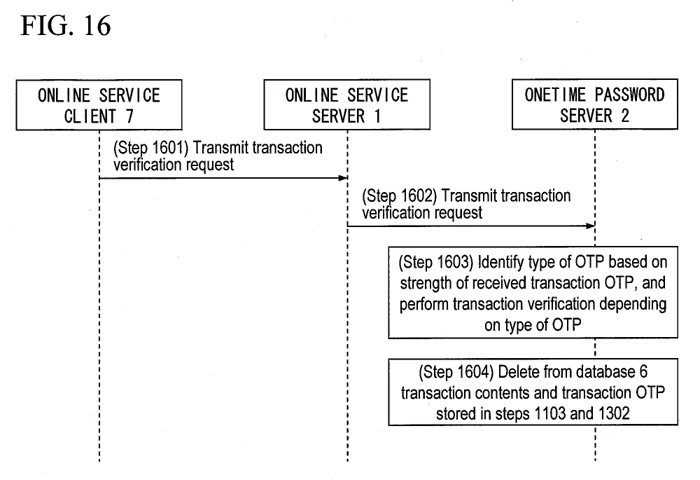

In the following, of the processes performed by the verification system of the invention, an example of a transaction verification process will be described with reference to FIG. 16.

In step 1601, the online service client 7 transmits a transaction verification request to the online service server 1, the request including a set of ID, a transaction OTP, and transaction contents.

It is noted, however, that step 1601 is carried out upon pressing of the transaction verification process enter button 1204 by the online service user.

In step 1602, the online service server 1 transmits a transaction verification request to the onetime password server 2, the request including the set of ID, transaction OTP, and transaction contents.

In step 1603, the onetime password server 2 identifies the type of the OTP based on the strength of the received transaction OTP, and then carries out the transaction verification process depending on the type of the transaction OTP.

The “transaction verification process depending on the type of transaction OTP” means the following:

(a) Transaction verification is considered a success if the strength of the transaction OTP received by the onetime password server 2 is equal to the strength of the transaction OTP (download method), the received set of ID, transaction OTP (download method), and transaction contents is stored in the transaction table 6004 of the database 6, and the current time is within a certain duration of time from the transaction contents reception time.
(b) Transaction verification is considered a success if the strength of the transaction OTP received by the onetime password server 2 is equal to the strength of the transaction OTP (two-way communication method), the received set of ID, transaction OTP (two-way communication method), and transaction contents is stored in the transaction table 6004 of the database 6, and the current time is within a certain duration of time from the transaction contents reception time.
(c) Transaction verification is considered a success if the strength of the transaction OTP received by the onetime password server 2 is equal to the strength of the transaction OTP (one-way communication method), the received set of ID, transaction OTP (one-way communication method), and transaction contents is stored in the transaction table 6004 of the database 6, and the current time is within a certain duration of time from the transaction contents reception time.

In step 1604, the onetime password server 2 deletes the record in the transaction table 6004 of the database 6 that includes the received ID.

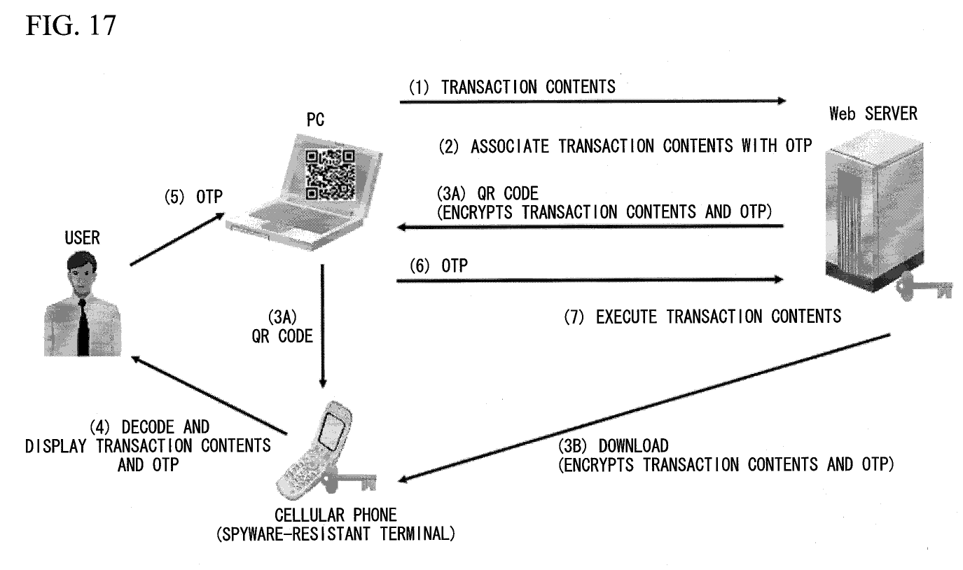

FIG. 17 shows the outline of the procedure starting with the transmission of transaction contents from the information terminal device 3 to the execution of the transaction contents using the transaction OTP.

A process 3A relates to the one-way communication method.

A process 3B relates to the download method.

Process 7 is carried out after confirmation by the onetime password server 2 of successful transaction verification.

In FIG. 17, the Web server corresponds to the online service server 1 and the onetime password server 2; PC corresponds to the information terminal device 3; and the cellular phone corresponds to the portable terminal device 4.

While in the foregoing embodiment the two-dimensional code consists of a QR code, it is also possible to use other two-dimensional codes, such as Maxi code, data matrix, PDF417, and RSS composite, for example.

The invention is also applicable to a PDA in which the information terminal device 3 and the portable terminal device 4 are integrated.

Furthermore, the invention is applicable to the execution of transactions of products advertised on a television receiver via digital television broadcast. In this case, a function equivalent to the information terminal device 3 according to the embodiment may be incorporated in the television receiver, and a function equivalent to the portable terminal device 4 according to the embodiment may be incorporated in the remote controller.

1. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying onetime passwords used for login verification and transaction contents verification,
wherein the onetime password server carries out login verification for online service and verification of transaction contents concerning online service using a onetime password received from the information terminal device,
the portable terminal device comprising:
means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords.

2. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying onetime passwords used for login verification and transaction contents verification,
wherein the onetime password server carries out login verification for online service and verification of transaction contents concerning online service using onetime passwords received from the information terminal device,
the information terminal device comprising:
means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor;
means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and
means for transmitting the transaction preparation information to the portable terminal device, and receiving the transaction-contents-verifying onetime password that is extracted by decoding the transaction preparation information in the portable terminal device using the common key shared with the onetime password server.

3. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying a onetime password used for login verification and transaction contents verification,
wherein the onetime password server carries out login verification for online service and verification of transaction contents concerning online service using onetime passwords received from the information terminal device,
the information terminal device comprising:
means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and
means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen,
the portable terminal device comprising:
means for restoring the challenge by decoding the two-dimensional code of the challenge displayed on a display screen of the information terminal device, and displaying a login-verifying onetime password generated using the challenge as a factor; and
means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

4. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying a onetime password used for login verification and transaction contents verification,
wherein the onetime password server carries out login verification for online service and verification of transaction contents concerning online service using onetime passwords received from the information terminal device,
the portable terminal device comprising:
means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords,
the information terminal device comprising:
means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor;
means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and
means for transmitting the transaction preparation information to the portable terminal device, and receiving the transaction-contents-verifying onetime password that is extracted by decoding the transaction preparation information in the portable terminal device using the common key shared with the onetime password server.

5. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying a onetime password used for login verification and transaction contents verification,
wherein the onetime password server carries out login verification for online service and verification of transaction contents concerning online service using onetime passwords received from the information terminal device,
the portable terminal device comprising:
means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords,
the information terminal device comprising:
means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and
means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen,
the portable terminal device comprising:
means for restoring the challenge by decoding the two-dimensional code of the challenge displayed on a display screen of the information terminal device, and displaying a login-verifying onetime password generated using the challenge as a factor; and
means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

6. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying a onetime password used for login verification and transaction contents verification,
wherein the onetime password server carries out login verification for online service and verification of transaction contents concerning online service using onetime passwords received from the information terminal device,
the information terminal device comprising:
means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor;
means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and
means for transmitting the transaction preparation information to the portable terminal device, and receiving the transaction-contents-verifying onetime password that is extracted by decoding the transaction preparation information in the portable terminal device using the common key shared with the onetime password server,
the information terminal device comprising:
means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and
means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen,
the portable terminal device comprising:
means for restoring the challenge by decoding the two-dimensional code of the challenge displayed on a display screen of the information terminal device, and displaying a login-verifying onetime password generated using the challenge as a factor; and
means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

7. A verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying a onetime password used for login verification and transaction contents verification,
wherein the onetime password server carries out login verification for online service and verification of transaction contents concerning online service using onetime passwords received from the information terminal device,
the portable terminal device comprising:
means for separately transmitting, to the onetime password server, an acquisition request for a login-verifying onetime password and an acquisition request for a transaction-contents-verifying onetime password, which passwords are necessary when the information terminal device receives online service from the online service server, receiving a login-verifying onetime password and a transaction-contents-verifying onetime password separately from the onetime password server, and displaying the passwords,
the information terminal device comprising:
means for transmitting a login verification screen acquisition request to the online service server, receiving a login verification screen including a challenge generated by the onetime password server in accordance with an instruction from the online service server to the onetime password server, displaying the received login verification screen, transmitting the received challenge to the portable terminal device, and receiving a login-verifying onetime password from the portable terminal device that is generated using the challenge as a factor;
means for transmitting a transaction verification screen acquisition request including transaction contents to the online service server, receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the transaction verification screen; and
means for transmitting the transaction preparation information to the portable terminal device, and receiving the transaction-contents-verifying onetime password that is extracted by decoding the transaction preparation information in the portable terminal device using the common key shared with the onetime password server,
the information terminal device comprising:
means for transmitting a login verification screen acquisition request to the online service server, receiving a login verification screen to which a challenge and a two-dimensional code of the challenge are added, the challenge being generated by the onetime password server in accordance with an instruction from the online service server to the onetime password server, and displaying the received login verification screen; and
means for transmitting a transaction verification screen acquisition request including transaction contents to the online service server, receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and displaying the received transaction verification screen,
the portable terminal device comprising:
means for restoring the challenge by decoding the two-dimensional code of the challenge displayed on a display screen of the information terminal device, and displaying a login-verifying onetime password generated using the challenge as a factor; and
means for restoring the transaction preparation information by decoding the two-dimensional code of the transaction preparation information displayed on the display screen of the information terminal device, extracting the transaction-contents-verifying onetime password and transaction contents by decoding the transaction preparation information using the common key, and displaying the transaction-contents-verifying onetime password and transaction contents.

8. The verification system according to claim 4, wherein the onetime password server comprises:
means for receiving, from the information terminal device via the online service server, a login verification request including a login-verifying onetime password and a transaction verification request including a transaction-contents-verifying onetime password, and identifying the type of the received login-verifying onetime password and the transaction-contents-verifying onetime password based on the strength of the login-verifying onetime password and that of the transaction-contents-verifying onetime password.

9. The verification system according to claim 2, wherein the information terminal device and the portable terminal device each comprise a wireless interface or an IC card interface for the transmission and reception of the challenge, login-verifying onetime password, transaction preparation information, and transaction-contents-verifying onetime password, using a wireless signal.

10. A verification method in a verification system,
the verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying onetime passwords used for login verification and transaction contents verification,
wherein the onetime password server carries out login verification for online service and verification of transaction contents concerning online service using a onetime password received from the information terminal device,
the verification method comprising the steps of:
in the portable terminal device,
separately transmitting to the onetime password server an acquisition request for a login-verifying onetime password and an acquisition request for a transaction-contents-verifying onetime password, which passwords are necessary when the information terminal device receives online service from the online service server,
receiving a login-verifying onetime password and a transaction-contents-verifying onetime password separately from the onetime password server; and,
displaying the passwords on a display.

11. A verification method in a verification system,
the verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying onetime passwords used for login verification and transaction contents verification,
wherein the onetime password server carries out login verification for online service and verification of transaction contents concerning online service using onetime passwords received from the information terminal device,
the verification method comprising the steps of:
in the information terminal device,
transmitting a login verification screen acquisition request to the online service server,
receiving a login verification screen including a challenge generated by the onetime password server in accordance with an instruction from the online service server to the onetime password server,
displaying the received login verification screen on a display,
transmitting the received challenge to the portable terminal device, and receiving a login-verifying onetime password from the portable terminal device that is generated using the challenge as a factor;
transmitting a transaction verification screen acquisition request including transaction contents to the online service server,
receiving a transaction verification screen to which transaction preparation information and the transaction contents are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server,
displaying the transaction verification screen;
transmitting the transaction preparation information to the portable terminal device; and,
receiving the transaction-contents-verifying onetime password that is extracted by decoding the transaction preparation information in the portable terminal device using the common key shared with the onetime password server.

12. A verification method in a verification system,
the verification system comprising:
an online service server for providing online service;
an information terminal device for receiving online service;
a onetime password server for carrying out a process relating to the verification of login of the information terminal device onto the online service server and the verification of transaction contents of online service; and
a portable terminal device owned by the user of the information terminal device who receives online service, the portable terminal device being used for displaying a onetime password used for login verification and transaction contents verification,
wherein the onetime password server carries out login verification for online service and verification of transaction contents concerning online service using onetime passwords received from the information terminal device,
the verification method comprising the steps of:
in the information terminal device,
transmitting a login verification screen acquisition request to the online service server,
receiving a login verification screen to which a challenge and a two-dimensional code of the challenge are added, the challenge being generated by the onetime password server in accordance with an instruction from the online service server to the onetime password server,
displaying the received login verification screen;
transmitting a transaction verification screen acquisition request including transaction contents to the online service server,
receiving a transaction verification screen to which transaction preparation information and a two-dimensional code of the transaction preparation information are added, wherein the transaction preparation information contains a set of a transaction-contents-verifying onetime password and the transaction contents that has been encoded by a common key shared by the onetime password server and the portable terminal device, the transaction-contents-verifying onetime password being generated by the onetime password server in accordance with an instruction from the online service server to the onetime password server, and,
displaying the received transaction verification screen,
the method further comprising the steps of:
in the portable terminal device,
restoring the challenge by decoding the two-dimensional code of the challenge displayed on a display screen of the information terminal device,
displaying a login-verifying onetime password generated using the challenge as a factor;
restoring the transaction preparation information by decoding the two-dimensional code of the transaction preparation information displayed on the display screen of the information terminal device,
extracting the transaction-contents-verifying onetime password and transaction contents by decoding the transaction preparation information using the common key; and,
displaying the transaction-contents-verifying onetime password and transaction contents on a display.

13. The verification system according to claim 4, wherein the information terminal device and the portable terminal device each comprise a wireless interface or an IC card interface for the transmission and reception of the challenge, login-verifying onetime password, transaction preparation information, and transaction-contents-verifying onetime password, using a wireless signal.

14. The verification system according to claim 6, wherein the information terminal device and the portable terminal device each comprise a wireless interface or an IC card interface for the transmission and reception of the challenge, login-verifying onetime password, transaction preparation information, and transaction-contents-verifying onetime password, using a wireless signal.

15. The verification system according to claim 7, wherein the information terminal device and the portable terminal device each comprise a wireless interface or an IC card interface for the transmission and reception of the challenge, login-verifying onetime password, transaction preparation information, and transaction-contents-verifying onetime password, using a wireless signal.

16. The verification system according to claim 5, wherein the onetime password server comprises:
means for receiving, from the information terminal device via the online service server, a login verification request including a login-verifying onetime password and a transaction verification request including a transaction-contents-verifying onetime password, and identifying the type of the received login-verifying onetime password and the transaction-contents-verifying onetime password based on the strength of the login-verifying onetime password and that of the transaction-contents-verifying onetime password.

17. The verification system according to claim 6, wherein the onetime password server comprises:
means for receiving, from the information terminal device via the online service server, a login verification request including a login-verifying onetime password and a transaction verification request including a transaction-contents-verifying onetime password, and identifying the type of the received login-verifying onetime password and the transaction-contents-verifying onetime password based on the strength of the login-verifying onetime password and that of the transaction-contents-verifying onetime password.

18. The verification system according to claim 7, wherein the onetime password server comprises:
means for receiving, from the information terminal device via the online service server, a login verification request including a login-verifying onetime password and a transaction verification request including a transaction-contents-verifying onetime password, and identifying the type of the received login-verifying onetime password and the transaction-contents-verifying onetime password based on the strength of the login-verifying onetime password and that of the transaction-contents-verifying onetime password.
